(19) United States
(12) Patent Application Publication
(10) Pub. No.: US 2021/0019304 A1
(43) Pub. Date: Jan. 21, 2021

(54) SYSTEM AND METHOD RETRIEVING, ANALYZING, EVALUATING AND CONCLUDING DATA AND SOURCES

(71) Applicant: fakeOut Ltd., Tel Aviv - Jaffa (IL)

(72) Inventors: Aaron NAHUMI, Tel Aviv - Jaffa (IL); Roi Sorezki, Tel Aviv - Jaffa (IL); Gil Matzliah, Kfar Saba (IL); Roman Krom, Kfar Saba (IL); Alon Valdezy, Ramat Gan (IL)

(73) Assignee: FakeOut Ltd., Tel Aviv - Jaffa (IL)

(21) Appl. No.: 16/946,575

(22) Filed: Jun. 26, 2020

Related U.S. Application Data
(60) Provisional application No. 62/874,038, filed on Jul. 15, 2019.

(51) Int. Cl. G06F 16/23; G06F 16/2458

(52) U.S. Cl. CPC G06F 16/2365; G06F 16/2465

(57) ABSTRACT

A method for finding at least one of a fake source and a fake data, the method may include obtaining, by a computerized system, a data from a source; determining a source reliability score; wherein the determining comprises finding other sources linked to the source and wherein the determining is based, at least in part, on at least one out of (a) one or more Engagement between the other sources and the source, and (b) one or more connections between the other sources and the source, and in addition to scores assigned to the other sources; calculating a data reliability score; wherein the calculating is responsive to at least one out of responses to the data and relationships between different instances of the data; and performing a synergetic analysis of the source reliability score and the data reliability score to provide one or more system conclusions, wherein the one or more system conclusions comprise an indication regarding at least one out of (a) whether the source is a face source, and (b) whether the data is fake data.

### CROSS REFERENCE

This application claims priority from U.S. provisional patent Ser. No. 62/874,038 filing date Jul. 15, 2019 which is incorporated herein by reference.

### BACKGROUND

The flow of Data substantially and dramatically increases all the time.

A vast amount of Fake Source and Fake Data flows exponentially over various types of media and means, directly or indirectly, including but not limited to, the internet, world wide web, deep net, sites, social networks, cyberspace, communication networks, etc..

Using Fake Source and/or Fake Data may cause a substantial amount of continuous damages and injuries, direct and indirect, including but not limited to, personal, social, financial, mental, etc..

There is a growing urgent need to retrieve, analyze, evaluate and conclude Source and Data.

### SUMMARY

There may be provided a method for finding at least one of a fake source and a fake data, the method may include obtaining, by a computerized system, a data from a source; determining a source reliability score; wherein the determining may include finding other sources linked to the source and wherein the determining may be based, at least in part, on at least one out of (a) one or more Engagement between the other sources and the source, and (b) one or more connections between the other sources and the source, and in addition to scores assigned to the other sources; calculating a data reliability score; wherein the calculating may be responsive to at least one out of responses to the data and relationships between different instances of the data; and performing a synergetic analysis of the source reliability score and the data reliability score to provide one or more system conclusions, wherein the one or more system conclusions may include an indication regarding at least one out of (a) whether the source may be a face source, and (b) whether the data may be fake data.

The other sources may be linked via one or more social network to the Source, the other sources may include at least one out of persons, other Sources, and websites.

The determining of the source reliability score may include scanning through multiple levels of social networks links with the source to find other sources, that may include Engagements, such as friends, connections, groups, liked items, favorites pages, habits and interests.

For each other source, the determining of the source reliability score may include measuring a set of various parameters, and correlation between other sources.

The determining of the source reliability score may include applying big data processing.

The determining of the source reliability score and the calculating of the data reliability score may be executed in parallel.

The determining of the source reliability score and the calculating of the data reliability score may be executed independently from each other.

The calculating of the data reliability score may include determining a type of the data and analyzing the data based on the type of the data.

There may be provided a non-transitory computer readable medium that may store instructions for obtaining, by a computerized system, a data from a source; determining a source reliability score; wherein the determining may include finding other sources linked to the source and wherein the determining may be based, at least in part, on at least one out of (a) one or more Engagement between the other sources and the source, and (b) one or more connections between the other sources and the source, and in addition to scores assigned to the other sources; calculating a data reliability score; wherein the calculating may be responsive to at least one out of responses to the data and relationships between different instances of the data; and performing a synergetic analysis of the source reliability score and the data reliability score to provide one or more system conclusions, wherein the one or more system conclusions may include an indication regarding at least one out of (a) whether the source may be a face source, and (b) whether the data may be fake data.

The other sources may be linked via one or more social network to the Source, the other sources may include at least one out of persons, other Sources, and websites.

The determining of the source reliability score may include scanning through multiple levels of social networks links with the source to find other sources, that may include Engagements, such as friends, connections, groups, liked items, favorites pages, habits and interests.

For each other source, the determining of the source reliability score may include measuring a set of various parameters, and correlation between other sources.

The determining of the source reliability score may include applying big data processing.

The determining of the source reliability score and the calculating of the data reliability score may be executed in parallel.

The determining of the source reliability score and the calculating of the data reliability score may be executed independently from each other.

The calculating of the data reliability score may include determining a type of the data and analyzing the data based on the type of the data

There may be provided a computerized system for finding fake information, the computerized system may include a processing circuit and an input output module; wherein the input output module may be configured to obtain a data from a source; wherein the processing circuit may be configured to determine a source reliability score; wherein the determining may include finding other sources linked to the source and wherein the determining may be based, at least in part, on at least one out of (a) one or more Engagement between the other sources and the source, and (b) one or more connections between the other sources and the source, and in addition to scores assigned to the other sources; calculate a data reliability score; wherein the calculating may be responsive to at least one out of responses to the data and relationships between different instances of the data; and perform a synergetic analysis of the source reliability score and the data reliability score to provide one or more system conclusions, wherein the one or more system conclusions may include an indication regarding at least one out of (a) whether the source may be a face source, and (b) whether the data may be fake data.

The processing circuit may be configured to scan through multiple levels of social networks links with the source to find other sources, that may include Engagements, such as friends, connections, groups, liked items, favorites pages, habits and interests.

For each other source, the processing circuit may be configured to determine the source reliability score by measuring a set of various parameters, and correlation between other sources.

The processing circuit may be configured to determine a type of the data and analyzing the data based on the type of the data.

The computerized system may be a computer, may include one or more computers, may include any type of computers such as cloud computers, remote computers, one or more servers, laptops, desktops, mobile phones, and the like.

### BRIEF DESCRIPTION OF THE DRAWINGS

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings in which:

FIG. 1 is an example of a method and various processing elements; and

FIG. 2 is an example of a method.

### DETAILED DESCRIPTION OF THE DRAWINGS

Any reference to “may be” should also refer to “may not be”.

Words denoting the singular include the plural and vice versa.

All descriptions, drawing and examples aimed for explaining the claims and/or constitute claims by themselves, but are not closed or exhaustive in any case with respect to any claim or the patentable subject matter of the invention.

In the following detailed description, numerous specific details are set forth in order to provide a thorough understanding of the one or more embodiments of the disclosure. However, it will be understood by those skilled in the art, that the present one or more embodiments of the disclosure may be practiced without these specific details. In other instances, well-known methods, procedures, and components have not been described in detail so as not to obscure the present one or more embodiments of the disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using electronic components and circuits known to those skilled in the art, details will not be explained in any greater extent than that considered necessary as illustrated above, for the understanding and appreciation of the underlying concepts of the present one or more embodiments of the disclosure and in order not to obfuscate or distract from the teachings of the present one or more embodiments of the disclosure.

Any reference in the specification to a method should be applied, mutatis mutandis, to a system capable of executing the method and should be applied, mutatis mutandis, to a non-transitory computer readable medium that stores instructions, that once executed by a computer result in the execution of the method.

Any reference in the specification to a system and any other component should be applied, mutatis mutandis, to a method that may be executed by a system and should be applied, mutatis mutandis, to a non-transitory computer readable medium that stores instructions, that may be executed by the system.

Any reference in the specification to a non-transitory computer readable medium should be applied, mutatis mutandis, to a system capable of executing the instructions stored in the non-transitory computer readable medium and should be applied, mutatis mutandis, to a method that may be executed by a computer, that reads the instructions stored in the non-transitory computer readable medium.

Any combination of any module or unit listed in any of the figures, any part of the specification and/or any claims may be provided. Especially any combination of any claimed feature may be provided.

Data can be distributed and/or shared, by or through multiple or plurality of Sources and/or various types of media and means, directly or indirectly, including but not limited to, the internet, world wide web, deep net, sites, social networks, cyberspace, communication networks, etc..

The system may retrieve, analyze, evaluate and conclude with respect to Source and Data solely and/or in fully or partially, use, interacted, integrated, combined, etc., with Related Technologies, in various and multiple ways (such as signage, odor, image, numerical, icon, symbol, graphic, text, visual, audio, audiovisual, etc.), including but not limited to, by creating and producing System Conclusions, with respect to Source and/or Data and/or Fake Source and/or Fake Data.

There may be provided a method for finding at least one of a fake source and a fake data, the method may include (a) obtaining, by a computerized system, a data from a source; (b) determining a source reliability score; wherein the determining comprises finding other sources linked to the source and wherein the determining is based, at least in part, on at least one out of (a) one or more Engagement between the other sources and the source, and (b) one or more connections between the other sources and the source, and in addition to scores assigned to the other sources; calculating a data reliability score; wherein the calculating is responsive to at least one out of responses to the data and relationships between different instances of the data; and performing a synergetic analysis of the source reliability score and the data reliability score to provide one or more system conclusions, wherein the one or more system conclusions comprise an indication regarding at least one out of (a) whether the source is a face source, and (b) whether the data is fake data. It should be noted that the definitions of “data”, “source”, “engagements”, “fake”, “fake data”, “fake source”, “related technologies” and “system conclusions” may be those provided below.

The term “Source” means, any type of source or source units, including but not limited to, media and/or database and/or traces and/or footprint and/or apparatus and/or human being and/or alive and/or dead and/or human and/or organism and/or persona and/or personality and/or identity and/or character and/or figure and/or artificial and/or judicial entity and/or association and/or organization and/or forum, etc., regardless if it is wholly, partially or none, inter alia, the self and/or generator and/or creator and/or contributor and/or imitator and/or promoter and/or influencer and/or relate and/or share, or just making any type of Engagements

The term “Data” means, any type of data or data units, including but not limited to, any type of database and/or big data and/or information and/or knowledge and/or know how and/or ideas and/or notions and/or content (such as signage, odor, image, numerical, icon, symbol, graphic, text, visual, audio, audiovisual, etc.).

The term “Fake Source” and/or “Fake Data” means, Source and/or Data that any of them is or may be, in whole or in part, include and/or consist and/or relate and/or rely and/or connected, inter alia, to real and/or actual and/or deemed and/or potential and/or suspected, in whole or in part, faked and/or unreal and/or disguised and/or invented and/or imagined and/or misinterpreted and/or exaggerated and/or not accurate and/or misleading and/or hoaxed and/or tainted and/or suspicious and/or indoctrinated and/or tendentious and/or prejudiced and/or one-sided and/or biased and/or partial and/or prepossessed and/or clickbait, objectively or subjectively, intentionally or not, with respect to various aspects, including but not limited to, those relating to facts, quality, quantity, accuracy, credibility, reliability, trends, sentiments, analysis, inductions, deductions, opinions, conclusions, evaluations, estimations, predictions, expressions, statements, situations, circumstances, etc..

The term “System Conclusions” means, inter alia, opinions and/or conclusions with respect to the Source and/or Data and/or Fake Source and/or Fake Data, whether separate System Conclusions relating separately to each (i.e., Source or Data) or combined System Conclusions relating jointly to Source and Data, including but not limited to, establishing, characterizing, stating, implying, negating, confirming, recommending, denoting, etc. and/or with respect to their Engagements and/or any relevant third parties' Engagements.

The term “Related Technologies” means, inter alia, third parties' (humans, machines or otherwise) technologies and/or knowledge and/or know how and/or Data, developed, made, invented, created programmed, planned in any way whatsoever, such as distributed computing and agile development, including but not limited to, any sort and type of apparatus, mechanical apparatus, manual apparatus, electronic apparatus, digital apparatus, humans, algorithms, crowd wisdom, cognitive learning, machine learning and/or models and/or meta-models based machine learning, that are using, implementing, applying or based, inter alia, on artificial intelligence, data mining, deep learning, insight learning, statistics, crawlers, clustering, segmenting, classifying, sentiment analyzing, recommender systems, prediction systems, natural language processing (NLP), natural language understanding (NLU) understanding, boosting, validating, filtering and interpretation, cyber, security, protection and deception technologies, Data, character, visual and voice recognition methods, iterative methods, convolutional neural networks, deep neural networks, multilayer perceptron networks, etc..

The term “Engagements” means, inter alia, any sort and type, whole, partial or combined, action and/or activity and/or operation and/or inaction and/or passivity and/or non-operating in relation and/or in connection, directly and/or indirectly to anything whatsoever, including but not limited to, Source and/or Data and/or Fake Source and/or Fake Data and/or network and/or social or otherwise oriented behavior network, or any part of any of the aforementioned, including but not limited to, through communicating (through any medium or technology, including but not limited to, electricity, electronic, digital, wire, wireless, television, computers, internet, telephone, cellular, mobile, radio, satellite, wi-fi, Bluetooth, etc.) engaging, acting, operating, reacting, non-acting, ignoring, non-operating, behaving, distributing, disseminating, feed-backing, echoing, feeding, foot printing, searching, browsing, responding, interacting, inviting, rejecting, suggesting, influencing, requesting, removing, attributing, acquaintances, intermediaries, linking, sharing, commenting, posting, reposting, tweeting, retweeting, favorite, grading, upgrading, downgrading, replying, mentioning, blogging, reblogging, meme, memeing, imitating, emoji, symbolizing, citing, opining, uploading, loading, downloading, unloading, installing, uninstalling, storing, retrieving, referring, relating, connecting, engaging, conversing, modifying, altering, amending, changing, adding, saving, paging, trackbacks, copying, rejecting, accepting, removing, following, unfollows, site, siting, publishing, connecting, becoming friends or terminating friends (including but not limited to unfriend, delete, remove, eliminate, disengage, disconnect, terminate etc.), liking, etc..

There may be provided a non-transitory computer readable medium, based, inter alia, on various or multiple tools and algorithms, including software, firmware, etc., operated automatically and/or manually solely and/or combined with manual actions, for providing information to any user, relating to the Source and/or Data and/or Fake Source and/or Fake Data, including but not limited to, by collect, assess, analyze, surface, map, locate, identify, detect, verify, evaluate, score, rank, prioritize, classify, cluster, profile, categorize or compare, aimed, inter alia, to relate to the Source and/or Data authenticity, truth, correctness, accuracy, prejudice, partiality, tendentiousness, factualness, credibility, reliability, identity or persona authenticity and existence, fakeness, disguise, etc..

The non-transitory computer readable medium of the invention may store instructions for applying algorithms, technologies and systems, and be combined and/or merged and/or assisted and/or analyzed , in whole or in part, with Related Technologies, that are relating, inter alia, to any past and/or present and/or future, Source and/or Data and/or Fake Source and/or Fake Data and/or any type of Engagements.

The system may provide solely and/or in fully or partially, use, interacted, integrated, combined, etc. with Related Technologies, in various and multiple ways ((such as signage, odor, image, numerical, icon, symbol, graphic, text, visual, audio, audiovisual, etc.), inter alia, System Conclusions, with respect to Source and/or Data and/or Fake Source and/or Fake Data.

The System Conclusions will be also the outcome of, quantitative and/or qualitative and/or synergetic analysis, comparison, interaction, linkage, orientation, union, intersection, configuration, merging, combining, prioritizing, etc., aiming to use the System Conclusions relating to the Source and/or Fake Source for the process of the System Conclusions with respect to the Data and/or Fake Data, and vice versa and/or to use the System Conclusions relating to the Data and/or Fake Data for the process of the System Conclusions with respect to the Source and/or Fake Source, and also using said process for System Conclusions all on a macro large scale basis and/or among any ingredients (identical, similar or different) of each with the other, on a micro, medium, small, nano scale basis.

The system, shall consists, inter alia, also from various algorithms of which their main function is to provide automatically, fully or partially, internal and/or external system control and self-repairing, with respect to system integrity, reliability, including but not limited to, by quality assurance and control, self-tuning, self-learning, self-improving, algorithms and parameters amending, all regarding past, present and future System Conclusions and/or any user's or any other third parties' type of Engagements, etc..

The system may alert world wide web users (such as social network ones) about Fake Source and/or Fake Data, including but not limited to regarding their Engagements, using various tools and algorithms.

The system will use its accumulated knowledge regarding other users' Source and/or Data and/or Fake Source and/or Fake Data, to provide System Conclusions to world wide web passive, non-active, non-operative, or low-key users, such as users with low or limited profile, marginal activities, low usability or any type of Engagements, etc.. For Example: If a user that is scored or ranked as “suspicious” and/or there are not minimal thresholds of the relevant parameters or indicators in its respect, such as number and/or quality of Engagements, etc., and as a result there is a difficulty or uncertainty, to rank, score, evaluate, opine or conclude regarding the user, based on its parameters and indicators, then the system algorithm, will then apply the System Conclusions regarding the Source and/or Data and/or Fake Source and/or Fake Data of other nearest, associated, relevant or similar (due to profile, characters, behavior, etc.) or other users.

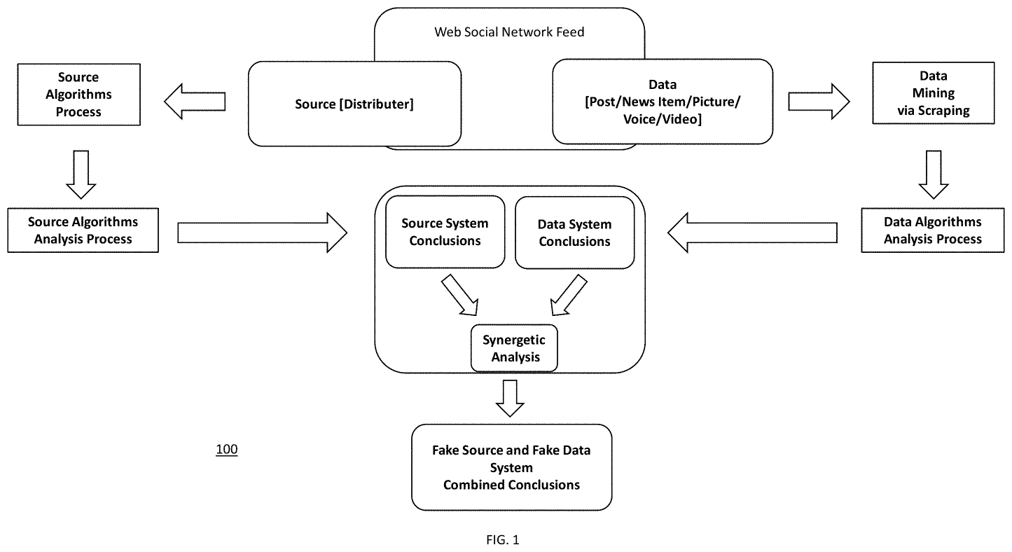

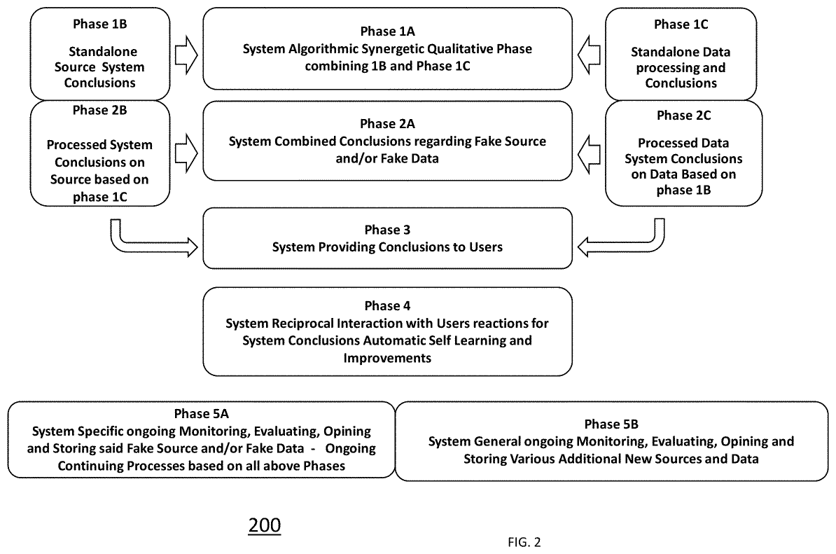

As illustrated in method 100 of FIG. 1 and method 200 of FIG. 2, the system may identify, evaluate, rank, score, prioritize, and provide with notifications and/or alerts with respect to the Fake Source and/or the Fake Data, relating for example to world wide web and any type of Source and/or Data connected herewith, such as, inter alia, web sites, static and/or interactive, regarding various types, fields, subjects, areas, verticals, segments and Engagements.

An example, details non exhaustive list of websites are is detailed in https://en.wikipedia.org/wiki/Lists_of_websites.

In addition, and without derogating from the stated generality there are, inter alia, web sites in the following fields: E-commerce, Business, Nonprofit, Educational, Entertainment, Informational, Blogs, Podcast, Personal, Chat, Data, Dictionaries, Encyclopedia, Gaming, Gambling, Forums, Community, Social, Social Media Social Network, Tor Hidden Services, Sharing (any type of Data, including but not limited to, text, audio, video, music, photos, odor, signage, etc.) including , Brochure, Portal, Wikis, Directories, Political, News, Corporate, SME websites, Consultation, Know How, Finance, Anti-Fraud, Fraud Detection, Fraud Prevention, Anti Laundering, Securities, Brand Protection, Reputation Protection, Goodwill Protection, Online Payment, Auction, Dating, Security, Software, Software Protection, Software Security, Endpoint Security, Cyber, Cyber Security, Search engines specific and general, Comparison, Comparison Shopping Engines (CSE's), Shopping, Tourism, Governmental, Authorities, Legal, Enforcement, etc..

The system may apply with respect to any user, such as social network user who wishes to be alerted of Fake Source, such as users following, responding and interacting with them and/or to be alerted of Fake Data and/or with respect to any Engagements in connection with Source and/or Data and/or Fake Source and/or Fake Data.

Most of the social network users prefer to interact with a Source that constitutes “real Source”, “real persona” and/or “real Data”, and to avoid from Fake Source and/or Fake Data and/or from any of their Engagements.

Fake Source and/or Fake Data perceived as elements that, without being, directly and/or indirectly, wholly or partially, informed, aware, know, conscious, sentience, etc,., are “affecting our minds and brain”, “manipulating our minds and brain”, “playing with our minds and brain”, “controlling our minds and brain” or “affecting our brain”. Therefore the ability of the system to notify and/or to provide alerts in that respect, is of essence and has a significant technological, scientific, tangible utility and contributory value, of any sort and type, such as financial, social, physical, spiritual, psychological, etc..

The system may enable its users to receive notifications and/or alerts automatically and/or after requesting, offline and/or online, including but not limited to, when a user will browse a social feed on the world wide web and/or through any device and/or application and/or software, they would be able to receive online notifications and/or alerts, in various ways, such as by text, voice, noise, image, odor, etc., regarding System Conclusions and/or Engagements of relevant Source and/or Data and/or Fake Source and/or Fake Data.

The Fake Source and/or Fake Data System Conclusions are the outcome of the algorithms technology applied, weighted, integrated, processed, etc., inter alia, on each of the two following pillars of the feed for evaluating the Source and/or the Data for opining and/or concluding if they are Fake Source and/or Fake Data:

a. The Source, that is displayed, communicated, presented or shared through any mean.
b. The Data that is displayed, communicated, presented or shared through any mean.

The system may provide solely and/or in fully or partially use, interaction, integration, combination, etc., with Related Technologies, in various and multiple ways (such as signage, odor, image, numerical, icon, symbol, graphic, text, visual, audio, audiovisual, etc.), inter alia, System Conclusions, with respect to Fake Source and/or Fake Data.

The Data is verified based, inter alia, for example on the links of the Source they are taken from. The Link of the Source rank, can be provided by the System and/or by Related Technologies, including but not limited to, those relating to Page Ranking, Domain Ranking and URL ranking

Assuming, for example, that the System is functioning and operating within N levels and layers through an algorithmic chain of events and actions in their respect and/or performing or executing various actions, milestones, tasks in a single line or plurality lines of the software, firmware, source code or programming code and/or acting through cascading complex data processing workflows and waterfalls and/or flowing down or up the algorithm within the hierarchy (i.e., first level, second level, etc., and vice versa).

The System is analyzing, ranking, scoring, evaluating, etc. the Source for example by drilling down into its Social Network's N levels, such as, friends, connections, groups, liked items, favorites pages, habits, interests, degrees of separation, etc. for example: First Level—direct connections, Second Level—indirect connections and so on.

For each Source, on each of the N levels, the System analyses, retrieves and measures a set of various parameters, and the inter linkage and correlation among them.

The System is utilizing accumulated big data in order to create general paradigm, profiles and assumptions, which shall be applied and utilized on each specific Source and/or Data.

### System Conclusions Relating to Source—Detailed Description

There are several levels to the Source analyzing, scoring, ranking, evaluating and opining process:
Basic eligibility analysis by defining minimal threshold to a set of Parameters, such as the following:
   Minimal/Maximal/Degree and Magnitude Scale, relating to user life cycle, sequences, events, existence duration, etc..
   Minimal/Maximal/Degree and Magnitude Scale, relating to number of contacts, friends. etc..
   Minimal/Maximal/Degree and Magnitude Scale, relating to number of ant type of Engagements, etc., including but not limited to, relating to any type of Engagements, etc..
   If the user is eligible and qualified (i.e., meet the necessary thresholds and parameters), then the system will apply a set of algorithmic and mathematic operations and calculations on different parameters (such as the profile and behavioral ones) and then the algorithm descriptions will be for example, as follows:
   Behavior analysis:
      [For example: average, accumulated, calculated, generated, statistical] Number of [profile and/or behavioral parameters]→Mathematical operator [/,×,+−, And, Or, NAND, Nor, XOR, if, else Etc’)]→[Avg, accumulated, calculated, generated, statistical] Number of [profile and behavioral parameters]=Quantitative and Qualitative Calculated/Generated Scalar (reflected, inter alia, by number, friction, %, or other types of indicators)
Threshold set up as described below:
   According to predefined thresholds, for each profile and behavior analysis, there shall be quantitative and qualitative findings.
The ranks/scores are calculated, generated and accumulated.
The overall rank/score defines the user level of reliability according to the User Level threshold.
System Conclusions relating to the Data.
   The System will use the System Conclusions relating to the Data for the process of the System Conclusions relating to the Source, and vice versa and also for providing Combined System Conclusions relating jointly to the Source and Data.
System Conclusions relating to the Source: Total user rank and score, relating, inter alia, to Source and/or Fake Source reliability and credibility submitted through various means of media and communication and displayed in various ways (such as signage, odor, image, numerical, icon, symbol, graphic, text, visual, audio, audiovisual, etc.).
Combined System Conclusions relating jointly to the Source, Data, Fake Source and fake Data, submitted through various means of media and communication and displayed in various ways (such as signage, odor, image, numerical, icon, symbol, graphic, text, visual, audio, audiovisual, etc.).

### System Conclusions Relating to Source—Examples

Each letter of the below example may denote and bear identical or different value, each time it is used independently within in any of the examples.
Behavior Analysis:
   # of Friends/Avg # of likes per post/repost
Thresholds (each letter might be identical or not):
   For users with Less than D Friends:
Less than A%—Fake
B%-C%—Suspicious
over C%—Real
   For users with a range of D-E Friends:
Less than F%—Fake
G%-H%—Suspicious
over H%—Real
   For users with a range of E-I Friends:
Less than J%—Fake
K%-L%—Suspicious
over M%—Real
   For users with a range of N-O Friends:
Less than P%—Fake
Q%-R%—Suspicious
over S%—Real
Behavior Analysis:
   Avg # of Engagements/Avg # of ‘likes’ per post/repost
Thresholds:
   For users with Less than D Friends:
Less than A%—Fake
B%-C%—Suspicious
over C%—Real
   For users with a range of D-E Friends:
Less than F%—Fake
G%-H%—Suspicious
over H%—Real
   For users with a range of E-I Friends:
Less than J%—Fake
K%-L%—Suspicious
over M%—Real
   For users with a range of N-O Friends:
Less than P%—Fake
Q%-R%—Suspicious
over S%—Real
Behavior Analysis:
   Number of months in Facebook/number of friends
Thresholds:
   For users with Less than D Friends:
Less than A%—Fake
B%-C%—Suspicious
over C%—Real
   For users with a range of D-E Friends:
Less than F%—Fake
G%-H%—Suspicious
over H%—Real
   For users with a range of E-I Friends:
Less than J%—Fake
K%-L%—Suspicious
over M%—Real
   For users with a range of N-O Friends:
Less than P%—Fake
Q%-R%—Suspicious
over S%—Real
Behavior Analysis:
   Number of friends that make Engagements (at least once)/number of friends
Thresholds:
   For users with Less than D Friends:
Less than A%—Fake
B%-C%—Suspicious
over C%—Real
   For users with a range of D-E Friends:
Less than F%—Fake
G%-H%—Suspicious
over H%—Real
   For users with a range of E-I Friends:
Less than J%—Fake
K%-L%—Suspicious
over M%—Real
   For users with a range of N-O Friends:
Less than P%—Fake
Q%-R%—Suspicious
over S%—Real

Related Technologies—All said process and examples includes the use, interaction, integration, combination, etc. of Related Technologies.

The linkage and correlation among the said various parameters can be, inter alia, reflected by percentage, multiplying, dividing, subtraction or any other algorithmically, arithmetic, mathematical (including aggregate, union and intersection phases), quantitative, qualitative, etc., evaluation and/or manipulation that can be applied for example on social networks, including but not limited to, applied on any type of Engagements in their respect.

Social network parameters and criteria can be provided and/or relied upon by any Source regarding any type of quantity and/or quality of Engagements,.

Each level and/or degree of connections, such as friends returns results, indications, evaluations and conclusions to the relevant algorithms levels among each of the N levels.

The System Conclusions are the synergetic aggregation outcome of each and all N levels analysis that will also determine what is Fake Source and/or Fake Data.

An example of a flow chart applied for evaluating Data is provided below:
Preliminary phase:
   Enter a social feed in an App or a Webpage (URL).
   Systematic Scan all the feed available and relevant Data, such as content.
   Retrieve all the Identities/Personas that took part in the feed.
   Collect all Identities/Personas elements, such as: profile, friends, feed items, shared items Engagements, commentators, commentators friends data, etc
Start few evaluation analysis processes in parallel:
   Identity/Persona credibility quality (“Phase A”).
Presented/Shared Data/content quality (“Phase B”).
Phase A: Source & Data collection
   Collect all posts, reposts and shared items.
   Collect all item sources.
   Collect all Engagements for each item.
   Collect Engagements Sources (e.g., Commentators).
   Collect Source connections, repeat above phases for each Source connection N levels.
Phase B: Source & Data analysis
   Various Calculations relating to any type of relations, Engagements, etc
   Determining Commenters Score.
   Take each one of the friends that commented and run the calculation on them.
   [calculate/generate UserScore].
   Add aggregate all the returned users score to the parent user.
   {userScore} calculate/generate user score added with all commenters Rank/Score.
   Check that post/repost number is sufficient for calculation > if not return score not available.
Data credibility analysis
   Identify Data types (e.g., Text, Image, Video, Link).
   Determine analysis method based on the Data type (e.g.,NLP, Links profile, Citation flow, Trust rank, Image recognition, Deep video analysis. etc.)
   Calculate/Generate Data score and providing System Conclusions, such as with respect to accuracy, truthfulness, credibility and reliability.

### System Conclusions Relating to Data—Detailed Description

There are several levels to the Data analyzing, scoring, ranking, evaluating and opining process.
For example: Is the Data sharable? If yes, continue.
Does the Data derives for example, from a well know, highly reliable and credible site, based, inter alia, on worldwide known ranking/scoring/trust/recommending sites/lists evaluated solely by the System or also by using, interacting, integrating, combining, etc. With Related Technologies→Provide Rank/Score.
Number of citations/Engagements in other sites, relating to the analyzed Data. Drill down to the site's ranking/scoring→Provide ranking/scoring according to citations/Engagements analysis.
Compare to the original site (verify the Data was not altered and if so adjust accordingly and repeat the analyzing process), using also Related Technologies such as NLP→Provide compared rank/score.
Provide accumulated rank/score.
If the Data turns out ‘suspicious’→combine the user integrity/reliability quantitative and qualitative rank/score with the Data accumulated quantitative and qualitative rank/score—The ongoing, evolving algorithm learns all the time, for example, from the user tendency to present or share suspicious information.

### Non Exhaustive Example

A user shares a story from CNN—CNN ranked and scored high in all worldwide known ranking/scoring/trust/recommending sites/lists.
Apply other algorithms, how long the story is ‘alive’, how many citations/Engagements in other sites, what is the rank/score of these sites→Calculate/Generate rank/score.
Validate the sharable Data with the original Data (verify it is the same pieces of Data).
Validate the user reliability/credibility, based on the Source analysis that described above).
Calculate/Generate accumulated rank/score for the presented/shared Data, then provide System Conclusions, for example relating to reliable/credible/accurate/suspicious level, according to the said defined thresholds.

### System Conclusions Relating to the Data

Total Data rank and score, relating, inter alia, to reliability and credibility submitted through various means of media and communication and displayed in various ways (such as signage, odor, image, numerical, icon, symbol, graphic, text, visual, audio, audiovisual, etc.).

### Combined System Conclusions Relating Jointly to the Source and Data

submitted through various means of media and communication and displayed in various ways (such as signage, odor, image, numerical, icon, symbol, graphic, text, visual, audio, audiovisual, etc.).

### Related Technologies

All said process and examples includes the use interaction, integration, combination, etc. of Related Technologies.

### System and Algorithmic Additional Description

Display outcome ranking and scoring of the Source, Data, Fake Source, Fake Data and combined Source, Data, Fake Source and Fake Data processes.
Display near each place that a Source and/or Data appears, the Source, Data and combined Source and Data rank and score.
Near each presented/shared item.
Display near each place that a Source and/or Data appears a synergetic Quantitative and Qualitative Rank and Score, relating to the Source, Data and the combined Source and Data.
Calculate/Generate the combined rank/score of the Content based of the Phase A and Phase B score/rank.
The combined rank is a result of a software defined, editable weight of each component Phase A and Phase B.
[Phase A+Phase B]—The algorithm can define (by the system developer or exported to the user a synergy between Phase A and Phase B calculated/generated results. The user/developer can define that a user that shares a low rank (lower than pre-defined threshold) at up to certain threshold percentage of his activities, such as shares, will ‘lose’ additional portion of the rank/score, according to the proportion of ‘low ranked shared feeds’ out of all feeds.
Textual, Visual or Audio Display of the combined score near the relevant Source and/or Data.

### Big Data Issues

Identify and define big data patterns in Sources (e.g., Web Users, etc.) any type of Engagements.
Distinguish credible/reliable from non-credible/reliable patterns with previously analyzed Sources' KPIs.
Apply credibility/reliability patterns as a separate KPI. i.e., it can influence on System Conclusions regarding Sources and/or Data without even measuring the KPI's of such Sources and/or Data.
Self and Machine Learning Improvements are accompanying all described processes, independently and/or by using Related Technologies.
Deepen and enrich scores with newly detected patterns, changes in connections and ongoing extraction of new Sources and Data (e.g., feed items, Engagements, etc.).

The foregoing description and examples have been presented for purposes of illustration only. It is not exhaustive and is not limited to the precise forms or embodiments disclosed. Modifications and adaptations will be apparent to those skilled in the art from consideration of the specification and practice of the disclosed embodiments.

Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, 4K Ultra HD Blu-ray, or other optical drive media, etc..

Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

The specification and/or examples and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination or otherwise of such integrated circuits.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method—respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product such as non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for finding at least one of a fake source and a fake data, the method comprises:
obtaining, by a computerized system, a data from a source;
determining a source reliability score; wherein the determining comprises finding other sources linked to the source and wherein the determining is based, at least in part, on at least one out of (a) one or more Engagement between the other sources and the source, and (b) one or more connections between the other sources and the source, and in addition to scores assigned to the other sources;
calculating a data reliability score; wherein the calculating is responsive to at least one out of responses to the data and relationships between different instances of the data; and
performing a synergetic analysis of the source reliability score and the data reliability score to provide one or more system conclusions, wherein the one or more system conclusions comprise an indication regarding at least one out of (a) whether the source is a face source, and (b) whether the data is fake data.

2. The method according to claim 1 wherein the other sources are linked via one or more social network to the Source, the other sources comprises at least one out of persons, other Sources, and websites.

3. The method according to claim 1 wherein the determining of the source reliability score comprises scanning through multiple levels of social networks links with the source to find other sources, that comprise Engagements, such as friends, connections, groups, liked items, favorites pages, habits and interests.

4. The method according to claim 3 wherein for each other source, the determining of the source reliability score comprises measuring a set of various parameters, and correlation between other sources.

5. The method according to claim 1 wherein the determining of the source reliability score comprises applying big data processing.

6. The method according to claim 1 wherein the determining of the source reliability score and the calculating of the data reliability score are executed in parallel.

7. The method according to claim 1 wherein the determining of the source reliability score and the calculating of the data reliability score are executed independently from each other.

8. The method according to claim 1 wherein the calculating of the data reliability score comprises determining a type of the data and analyzing the data based on the type of the data.

9. A non-transitory computer readable medium that stores instructions for:
obtaining, by a computerized system, a data from a source;
determining a source reliability score; wherein the determining comprises finding other sources linked to the source and wherein the determining is based, at least in part, on at least one out of (a) one or more Engagement between the other sources and the source, and (b) one or more connections between the other sources and the source, and in addition to scores assigned to the other sources;
calculating a data reliability score; wherein the calculating is responsive to at least one out of responses to the data and relationships between different instances of the data; and
performing a synergetic analysis of the source reliability score and the data reliability score to provide one or more system conclusions, wherein the one or more system conclusions comprise an indication regarding at least one out of (a) whether the source is a face source, and (b) whether the data is fake data.

10. The non-transitory computer readable medium according to claim 9 wherein the other sources are linked via one or more social network to the Source, the other sources comprises at least one out of persons, other Sources, and websites.

11. The non-transitory computer readable medium according to claim 9 wherein the determining of the source reliability score comprises scanning through multiple levels of social networks links with the source to find other sources, that comprise Engagements, such as friends, connections, groups, liked items, favorites pages, habits and interests.

12. The non-transitory computer readable medium according to claim 11 wherein for each other source, the determining of the source reliability score comprises measuring a set of various parameters, and correlation between other sources.

13. The non-transitory computer readable medium according to claim 9 wherein the determining of the source reliability score comprises applying big data processing.

14. The non-transitory computer readable medium according to claim 9 wherein the determining of the source reliability score and the calculating of the data reliability score are executed in parallel.

15. The non-transitory computer readable medium according to claim 9 wherein the determining of the source reliability score and the calculating of the data reliability score are executed independently from each other.

16. The non-transitory computer readable medium according to claim 9 wherein the calculating of the data reliability score comprises determining a type of the data and analyzing the data based on the type of the data

17. A computerized system for finding fake information, the computerized system comprises a processing circuit and an input output module;
wherein the input output module is configured to obtain a data from a source;
wherein the processing circuit is configured to:
determine a source reliability score; wherein the determining comprises finding other sources linked to the source and wherein the determining is based, at least in part, on at least one out of (a) one or more Engagement between the other sources and the source, and (b) one or more connections between the other sources and the source, and in addition to scores assigned to the other sources;
calculate a data reliability score; wherein the calculating is responsive to at least one out of responses to the data and relationships between different instances of the data; and
perform a synergetic analysis of the source reliability score and the data reliability score to provide one or more system conclusions, wherein the one or more system conclusions comprise an indication regarding at least one out of (a) whether the source is a face source, and (b) whether the data is fake data.

18. The computerized system according to claim 17 wherein the processing circuit is configured to scan through multiple levels of social networks links with the source to find other sources, that comprise Engagements, such as friends, connections, groups, liked items, favorites pages, habits and interests.

19. The non-transitory computer readable medium according to claim 11 wherein for each other source, the processing circuit is configured to determine the source reliability score by measuring a set of various parameters, and correlation between other sources.

20. The computerized system according to claim 17 wherein the processing circuit is configured to determine a type of the data and analyzing the data based on the type of the data.
